(19) United States
(12) Patent Application Publication
(10) Pub. No.: US 2006/0198564 A1
(43) Pub. Date: Sep. 7, 2006

(54) Linear guideway with rolling element retainer chain

(75) Inventors: Wang Chin-Pei, Taichung (TW); Tsai Chiung-Hui, Taichung (TW)

Correspondence Address: CHARLES E. BAXLEY, ESQ., 90 JOHN STREET, THIRD FLOOR, NEW YORK, NY, 10038, US

(73) Assignee: Hiwin Technologies Corp.

(21) Appl. No.: 11/075,000

(22) Filed: Mar. 7, 2005

(51) Int. Cl. F16C 29/06

(52) U.S. Cl. 384/45

(57) ABSTRACT

The present invention relates to a rolling element retainer chain for a linear guideway in accordance with the present invention comprises: a loading retainer and a return retainer, wherein the loading retainer and the return retainer are provided with a receiving groove, respectively, for passage of the rolling element retainer chain, at an end of the receiving groove of the loading retainer is formed a chamfer.

### BACKGROUND OF THE INVENTION

1. Field of the Invention

The present invention relates to a rolling element retainer chain for a linear guideway, and more particularly to a rolling element retainer chain that allows the rolling elements to move stably.

2. Description of the Prior Arts

Linear guideway with rolling element retainer chain has been widely used on all types of precision sliding equipment, such as numerical control machine, automatic welding machine, transportation facilities, and the like. A general linear guideway is usually assembled in such a way that the rolling elements move endlessly along an annular rolling path, while a linear guideway with rolling element retainer chain must be provided in the whole circulating path with receiving groove for the passage of the linking portion of the rolling element retainer chain. However, the receiving groove of the whole circulating path is not a unitary structure but made up of several separate parts, consequently, a height difference will be caused at the connection between the separate parts, this will adversely affect the movement of the linking portion of the rolling element retainer chain.

As shown in FIGS. 1 and 2, a sliding block 11 is mounted on a conventional linear guideway with rolling element retainer chain, the linear guideway generally includes a loading retainer 12 and a return retainer 13. The loading retainer 12 and the return retainer 13 are provided with a receiving groove 121, 131, respectively, for the passage of a rolling element retainer chain 14. The rolling element retainer chain 14, as shown in FIG. 3, comprises a linking portion 141 on which are disposed a plurality of spacers 143 for separating the rolling elements 142 from one another.

The connection between the receiving groove 131 of the return retainer 13 and the receiving groove 121 of the loading retainer 12 is not specially designed, when the linking portion 141 of the rolling-element retaining chain 14 moves to the loading retainer 12 from the return retainer 13, some problems are likely to take place, they are to be explained as follows:

First, the rolling element retainer chain 14 of the conventional linear guideway is usually made of flexible plastic so as to make it easier to go through return retainer 13. However, when approaching the connecting portion between the return retainer 13 and the loading retainer 12, the linking portion 141 will abut against the outer periphery of the receiving groove 131 because of elasticity, as shown in FIG. 4, in which, the rolling element retainer chain 14 is simplified by a rectangular strip. When moving to the connecting portion, an angular deviation will be caused such that the rolling element retainer chain 14 will not move in the predetermined direction of the blank arrow, but will move in the real direction as indicated by the solid arrow.

Second, the loading retainer 12 is assembled with other components normally by means of pins, however, height difference will take place between the receiving groove 131 of the return retainer 13 and the receiving groove 121 of the loading retainer 12 due to the fitting and manufacturing tolerance.

Based on the above-mentioned reasons, with reference to FIG. 6, when the linking portion 141 of the rolling element retainer chain 14 passes through the receiving groove 131 of the return retainer 13, it will hit the edge of the receiving groove 121 of the loading retainer 12, such a running module will cause an unstable running of the rolling elements.

To solve this problem, JP Patent No. 3349238 discloses a linear guideway, in which, the connecting portion of the circulating path is not at the abutting surface between the return retainer and the loading retainer, so that the rolling elements can get through the connecting portion smoothly by adjusting the moving direction. However, this design improves the difficulty of manufacturing.

The present invention has arisen to mitigate and/or obviate the afore-described disadvantages.

### SUMMARY OF THE INVENTION

The primary objective of the present invention is to provide a rolling element retainer chain for a linear guideway that allows the rolling elements to move stably.

The secondary objective of the present invention is to provide a rolling element retainer chain for a linear guideway that can be made more easily.

A rolling element retainer chain for a linear guideway in accordance with the present invention comprises: a loading retainer and a return retainer, wherein the loading retainer and the return retainer are provided with a receiving groove, respectively, for passage of the rolling element retainer chain, at an end of the receiving groove of the loading retainer is formed a chamfer.

The present invention will become more obvious from the following description when taken in connection with the accompanying drawings, which show, for purpose of illustrations only, the preferred embodiment in accordance with the present invention.

### BRIEF DESCRIPTION OF THE DRAWINGS

FIG. 1 is an exploded view of a conventional rolling element retainer chain for a linear guideway;

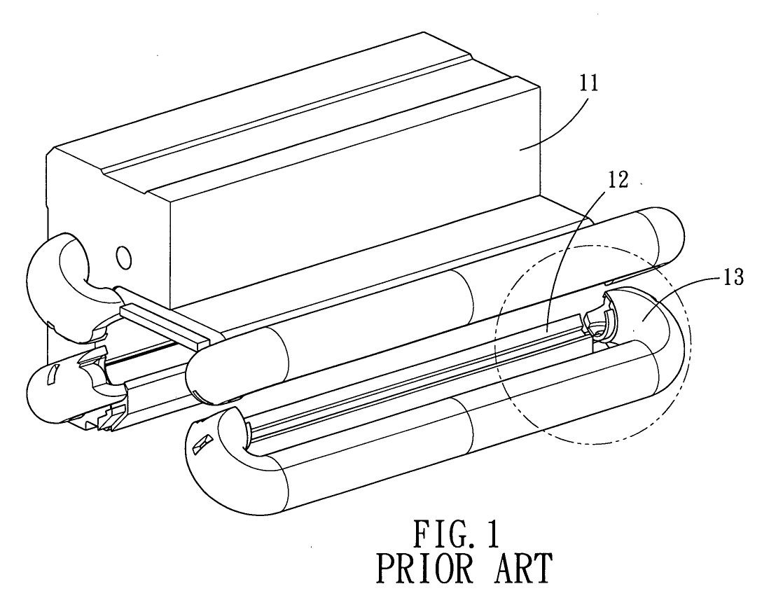

FIG. 2 is an enlarged view of a part of FIG. 1;

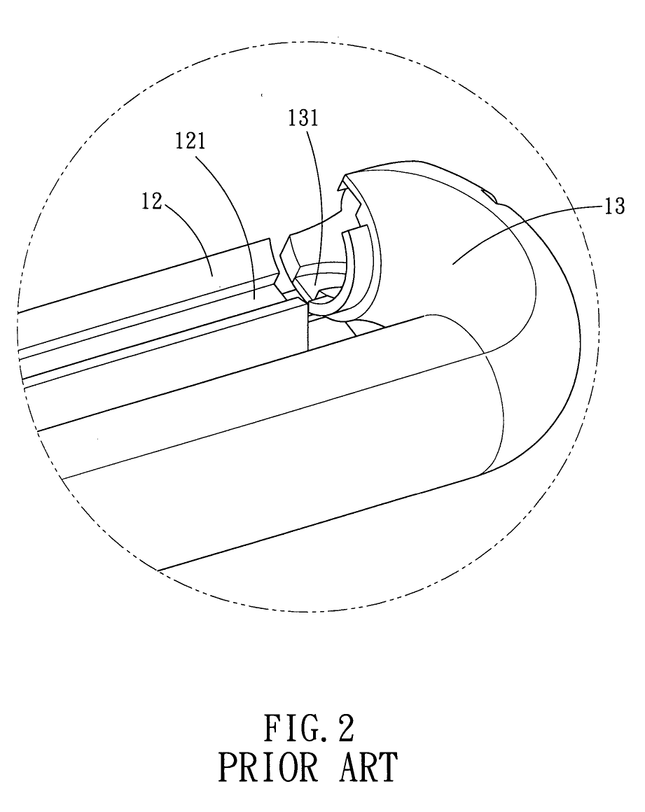

FIG. 3 is a perspective view of the conventional rolling element retainer chain;

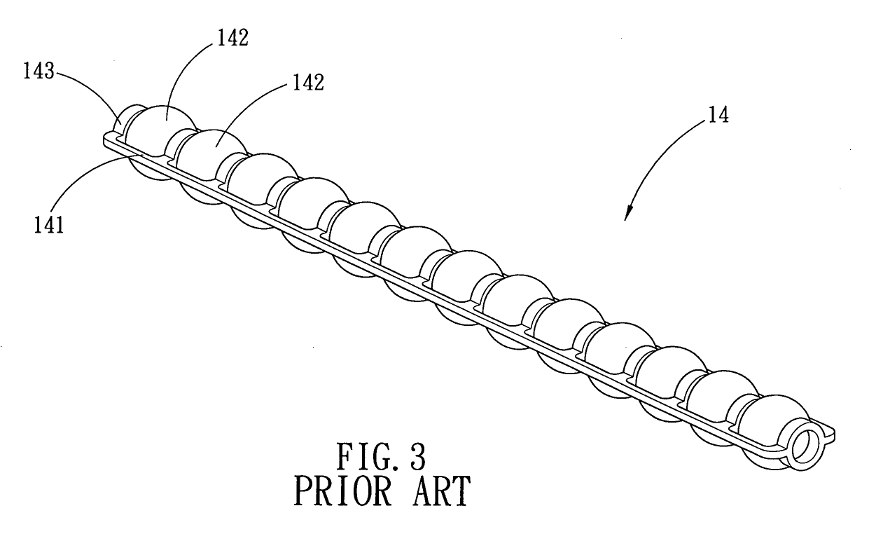

FIG. 4 is operational view of showing the conventional rolling element retainer chain is moving within the return retainer;

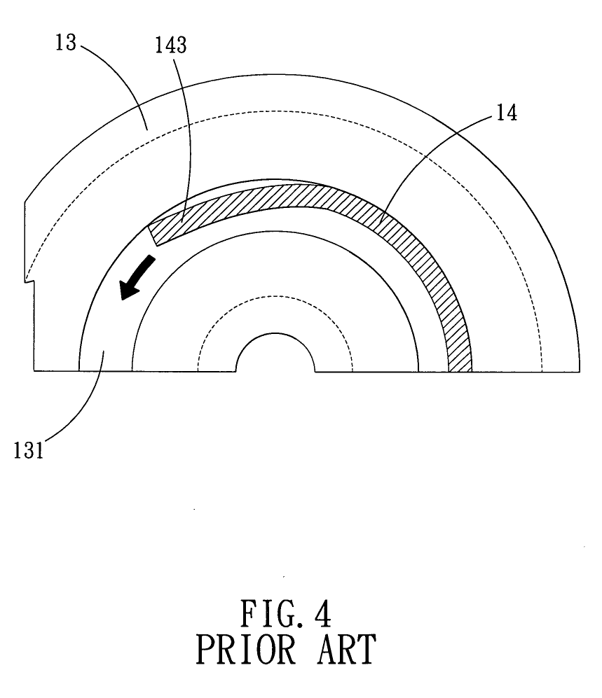

FIG. 5 is operational view of showing the conventional rolling element retainer chain is moving through the return retainer;

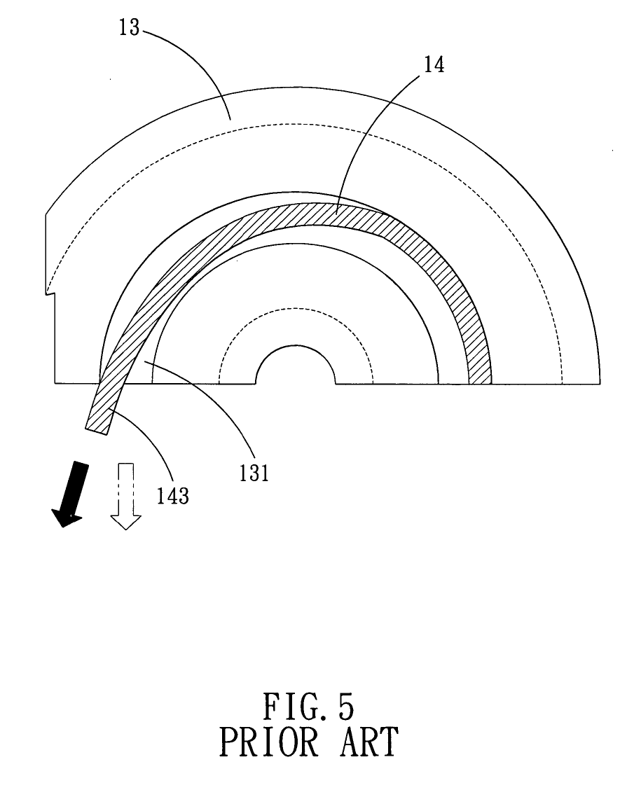

FIG. 6 is operational view of showing the conventional rolling element retainer chain hitting the edge of the loading retainer after moving out of the return retainer;

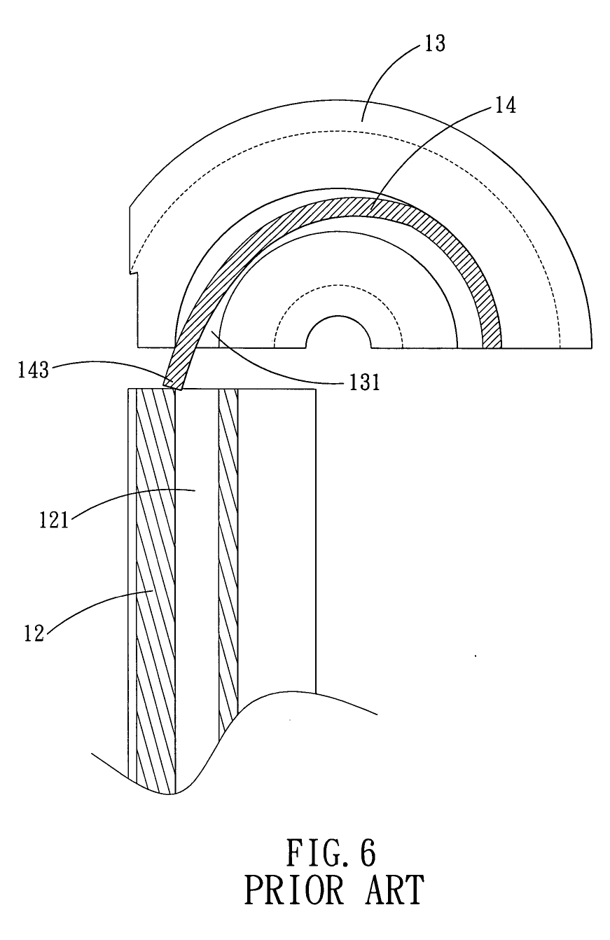

FIG. 7 is a cross sectional view of a rolling element retainer chain for a linear guideway in accordance with the present invention;

FIG. 8 is an operational view of the rolling element retainer chain for a linear guideway in accordance with the present invention;

FIG. 9 is an illustrative view of showing the chamfer;

FIG. 10 is a second illustrative view of showing the chamfer;

FIG. 11 is a third illustrative view of showing the chamfer.

### DETAILED DESCRIPTION OF THE PREFERRED EMBODIMENT

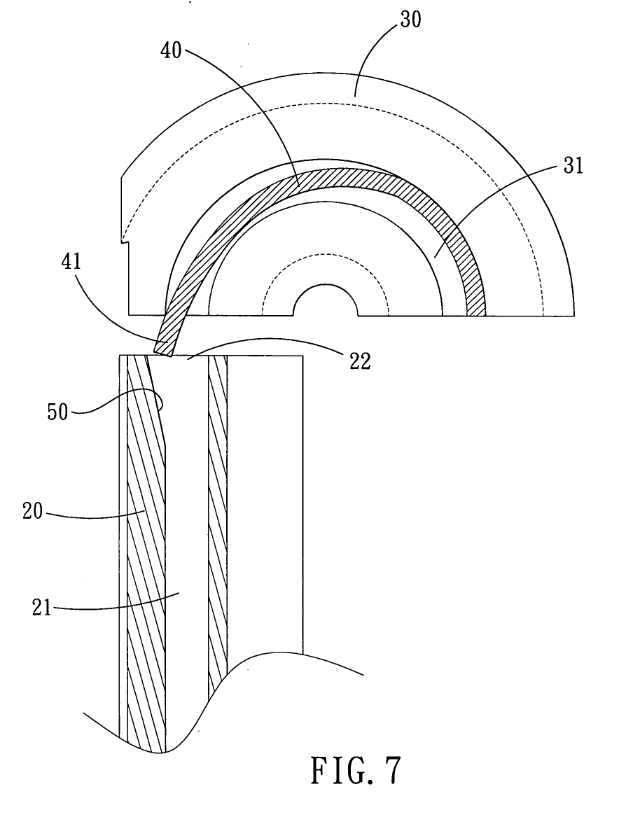

Referring to FIG. 7, a rolling element retainer chain for a linear guideway is shown and comprises: a loading retainer 20 and a return retainer 30, which are provided with a receiving groove 21, 31, respectively, for passage of the rolling element retainer chain 40 with linking portion 41. At an end 22 of the receiving groove 21 of the loading retainer 20 is formed a chamfer 50 which is located an abutting end of the loading retainer 20 connecting to the receiving groove 31 of the return retainer 30.

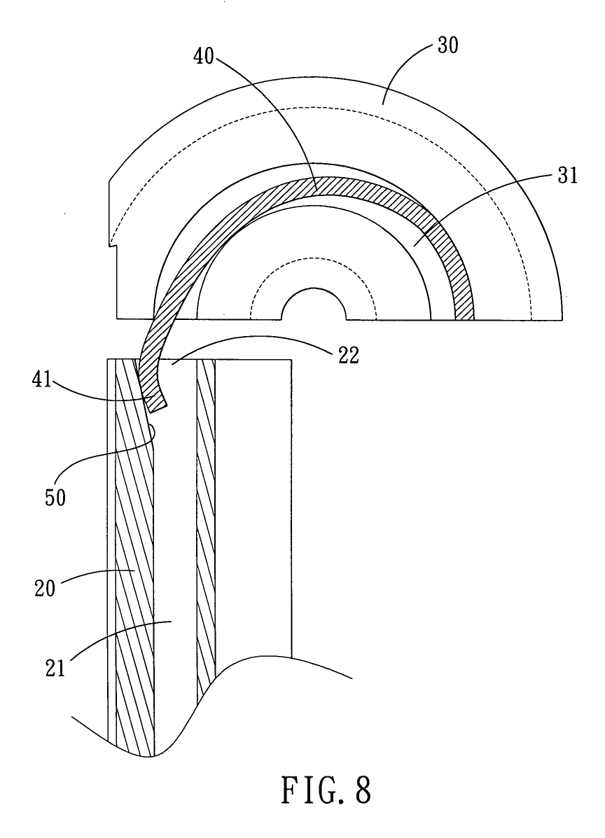

Referring to FIG. 8, the chamfer 50 can be used to absorb the movement deviation of the linking portion 41 at an end of the rolling element retainer chain 40, so that the linking portion 41 of the rolling element retainer chain 40 can get through the height difference at the connecting portion between the return retainer 30 and the loading retainer 20 without failure. Since the structure of loading retainer 20 is changed within a small range, this makes production easy.

It will be noted that the dimension of the chamfer 50 is calculated by the following steps:

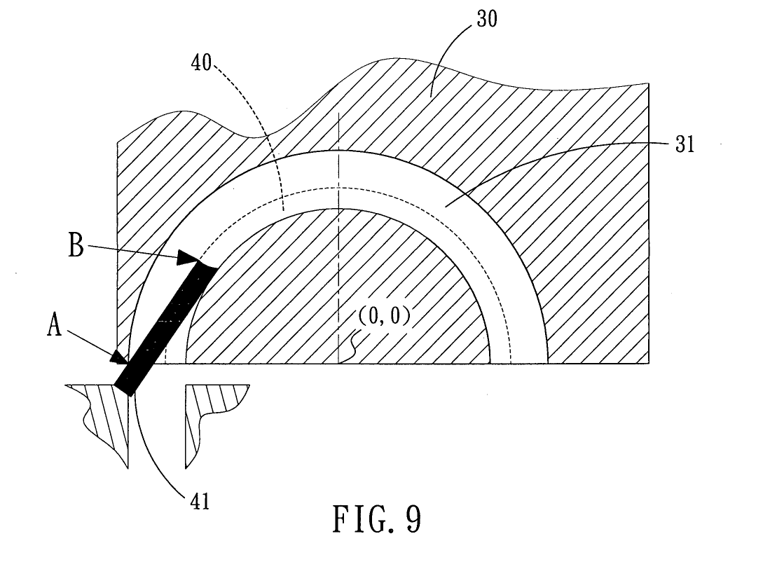

As shown in FIG. 9, suppose that the linking portion 41 of the rolling element retainer chain 40 is rigid, since the linking portion 41 is rigid when its recovery force reaches the maximum value, through this way, the maximum width of the chamfer can be figured out. Suppose that there are two restriction points A and B, point A is a corner point at the end of the outer edge of the receiving groove 31, while point B is a tangent point between the surface of the linking portion 41 of the rolling element retainer chain 40 and the inner surface of the receiving groove 31 of the return retainer 30. In this embodiment, the curvilinear equation is an equation of circle, namely, the return portion of the return retainer is a semicircle.

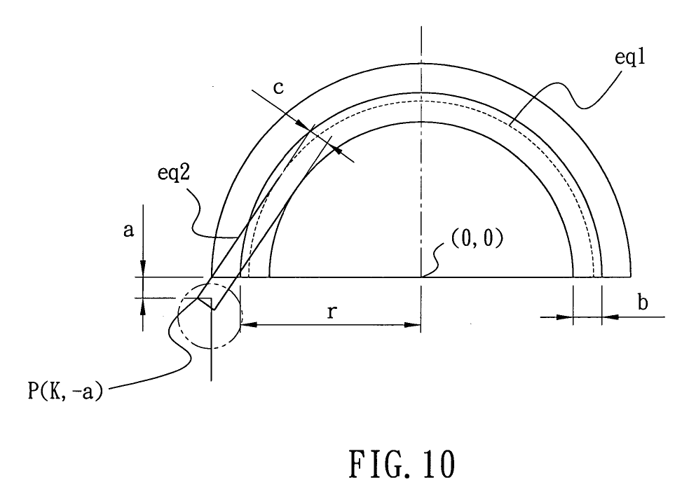

Referring to FIG. 10, which shows the respective parameters:
a: the height difference between the receiving groove of the return retainer and that of the loading retainer;
b: the width of the receiving groove of the return retainer;
c: the thickness of the rolling element retainer chain;
k: the x-axis value of the chamfer to be made;
r: the radius of the return path of the return retainer;
P: the predetermined corner point (the outmost point that the rolling element retainer chain will touch);
eq1: the curvilinear equation of the tangent outer edge of the rolling element retainer chain (it is equation of circle in this embodiment);
eq2: the straight-line equation of the outer edge of the rolling element retainer chain, the slop ratio of the eq2 is −d (d<0 in this embodiment);

Then the following equations can be obtained:
x²+y²=(r−b+c)² eq1
x−(−r−b)+dy=0 eq2
eq1 and eq2 insect at a point

$${x}^{2} + {[ \frac{- x - ( r + b )}{d} ]}^{2} = {( r - b + c )}^{2}$$

can be simplified as:
r−b+c=A r+b=B

$${x}^{2} + ( \frac{2 B}{{d}^{2} + 1} ) x + ( \frac{{B}^{2} - {d}^{2} {A}^{2}}{{d}^{2} + 1} ) = 0$$

If there is a double root, then it can get:

$${( \frac{2 B}{{d}^{2} + 1} )}^{2} - 4 \cdot 1 \cdot ( \frac{{B}^{2} - {d}^{2} {A}^{2}}{{d}^{2} + 1} ) = 0$$

$$d = \frac{- \sqrt{( {B}^{2} - {A}^{2} )}}{A} = \frac{- \sqrt{( 2 r + c ) ( 2 b - c )}}{r + c - b}$$

so coordinates of point P will be

$$( - \frac{a \sqrt{( 2 r + c ) ( 2 b - c )}}{r + c - b} - r - b ' - a ) .$$

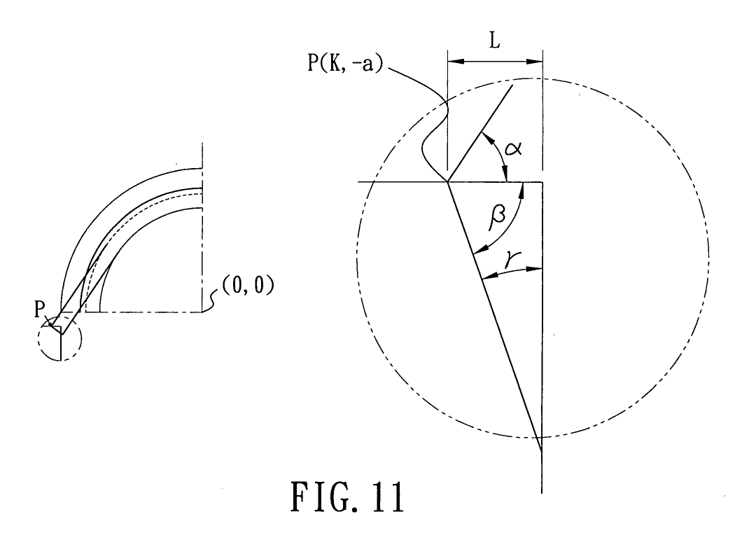

Referring next to FIG. 11, which shows the respective parameters as follows:
α: the angle between the linking portion of the rolling element retainer chain and the horizontal line;
γ=90°−β: angle of the chamfer;
L width of the chamfer

Then the following equations can be obtained:

$$L = \vert k - r - b \vert = \frac{a \sqrt{( 2 r + c ) ( 2 b - c )}}{r + c - b}$$

$$tan α = - d = \frac{\sqrt{( 2 r + c ) ( 2 b - c )}}{r + c - b}$$

$$α = {tan}^{- 1} ( \frac{\sqrt{( 2 r + c ) ( 2 b - c )}}{r + c - b} )$$

To make the linking portion of the rolling-element retaining chain have enough energy to move toward the negative Y-axis, the angle between the linking portion and the surface of the chamfer should be greater than 90.
α+β>90°
α>90°−β=γ

$${tan}^{- 1} ( \frac{\sqrt{( 2 r + c ) ( 2 b - c )}}{r + c - b} ) > γ$$

conclusions: width L of the chamfer should be greater than

$$\frac{a \sqrt{( 2 r + c ) ( 2 b - c )}}{r + c - b}$$

and angle γ of the chamfer should be less than

$${tan}^{- 1} ( \frac{\sqrt{( 2 r + c ) ( 2 b - c )}}{r + c - b} )$$

While we have shown and described various embodiments in accordance with the present invention, it should be clear to those skilled in the art that further embodiments may be made without departing from the scope of the present invention.

What is claimed is:

1. A linear guideway with rolling element retainer chain comprising a loading retainer and a return retainer, wherein the loading retainer and the return retainer are provided with a receiving groove, respectively, for passage of the rolling element retainer chain, at an end of the receiving groove of the loading retainer is formed a chamfer.

2. The linear guideway with rolling element retainer chain as claimed in claim 1; wherein width L of the chamfer is greater than
$$\frac{a \sqrt{( 2 r + c ) ( 2 b - c )}}{r + c - b}$$
a: the height difference between the receiving groove of the return retainer and that of the loading retainer;
b: the width of the receiving groove of the return retainer;
c: the thickness of the rolling element retainer chain;
r: the radius of the return path of the return retainer.

3. The rolling element retainer chain for a linear guideway as claimed in claim 1; wherein angle γ of the chamfer should be less than
$${tan}^{- 1} ( \frac{\sqrt{( 2 r + c ) ( 2 b - c )}}{r + c - b} )$$
, and the respective parameters are explained bellow:
b: the width of the receiving groove of the return retainer;
c: the thickness of the rolling element retainer chain;
r: the radius of the return path of the return retainer.
